(19) United States
(12) Patent Application Publication
(10) Pub. No.: US 2010/0168710 A1
(43) Pub. Date: Jul. 1, 2010

(54) DEVICE

(76) Inventor: Philip Braithwaite, Cheltenham (GB)

Correspondence Address: APEX JURIS, PLLC, 12733 LAKE CITY WAY NORTHEAST, SEATTLE, WA, 98125, US

(21) Appl. No.: 12/523,687

(22) PCT Filed: Jan. 17, 2008
(86) PCT No.: PCT/GB2008/000159

§ 371 Date: Mar. 16, 2010

(30) Foreign Application Priority Data
Jan. 17, 2007 (GB) 0700839.4

(51) Int. Cl. A61J 1/14; B29C 65/14

(52) U.S. Cl. 604/403; 156/275.1

(57) ABSTRACT

There is described a medicament container assembly (1) comprising a medicament compartment (2); a first cover (3) including a preformed medicament outlet (4); and a second cover (5).

### FIELD OF THE INVENTION

The present invention relates to a novel medicament container. The invention also relates to medical devices and methods of treatment utilising such containers and to novel methods of manufacturing such containers and/or medical devices.

### BACKGROUND TO THE INVENTION

Known powder inhalation devices, such as, for example, Accuhaler®, comprise a single dose of powdered medicament packaged in a foil covered blister. In use it usual for the foil to be ruptured and the powdered medicament is vented from the container. However, it is a common disadvantage of such containers that the area immediately surrounding the rupture acts as a trap, e.g. with folds of the ruptured foil, that causes some of the powdered medicament to be retained in the container. This can lead to the patient receiving an inconsistent dosage of the medicament which is undesirable and potentially dangerous.

International Patent application No. WO 01/72605 describes a dose strip for use with a dry powder inhaler (DPI), which includes a base strip having spaced apart blisters and a lid strip which is attached over the base strip. Lid tabs are attached to the lid strip over each blister and a peel strip is pulled away from the base strip and lid strip, causing a lid tab to shear open the lid strip. However, the inhaler and/or blisters described suffer from the disadvantage that a high degree of powder retention still remains because, inter alia, the respiratory flow is not directed towards the powder.

International Patent application No WO 2005/030305 attempts to overcome the problem of the prior art devices and describes a medicament container comprising a frangible closure wall at least a portion of which is ruptured outwardly. However, a disadvantage of the system described is illustrated in the first embodiment of the invention of the prior art application. Particular reference may be made to FIG. 1c, where it can be seen that, the use of a U shaped blade (11) still ruptures the frangible wall inwardly.

Furthermore, both of the aforementioned prior art devices suffer from the disadvantage that they are not reclosable. The disadvantage of a medicament container which does not empty fully is exacerbated by the fact that it is not reclosable, since any unused powder will be left open to the devices as a whole and can contaminate and/or clog the device.

We have now surprisingly found a novel system which overcomes or mitigates the disadvantages of the prior art devices.

### STATEMENTS OF THE INVENTION

Thus, according to a first aspect of the invention, we provide a medicament container assembly comprising a medicament compartment; a first cover including a preformed medicament outlet; and a second cover.

The medicament compartment may comprise a variety of materials, however, preferentially, it comprises a moulded plastics material. The medicament compartment may comprise an integral moulded plastics compartment or alternatively, it may comprise a walled chamber with a non integral base. The use of a non-integral base is especially advantageous in the manufacture and/or filling of the chamber as will be described hereinafter. The medicament compartment will preferably comprise a medicament retaining chamber and a lip. The lip may preferably be substantially circumferential to the chamber.

The first cover is preferably a rigid or semi rigid preformed plastics cover adapted to be fitted to the medicament compartment. In its simplest form the cover may comprise only a single medicament outlet. However, preferably, the cover also includes an air inlet. The air inlet may simply comprise an aperture, optionally corresponding in size and/or shape to the medicament outlet. However, the incorporation of the air inlet and or the medicament outlet into a preformed plastics cover is especially advantageous in that, inter alia, the inlet and/or the outlet may be adapted to facilitate improved features. Thus, for example, the air inlet may be adapted to facilitate deagglomeration of the medicament, by the use of a plurality of air inlets. The plurality of air inlets may be in the form of a grill. In a further alternative the air flow and/or the medicament flow may be tuned or regulated by the use of different sized apertures. The first cover is preferentially sized and shaped so that it substantially overlies the lip of the compartment.

Thus, in an especially preferred embodiment the compartment and the first cover both comprise plastics material. Each of the plastics materials may be the same or different, however, preferentially each of the compartment and the first cover comprise the same plastics material.

The second cover preferably comprises a moisture resistant material. Thus, for example, the second cover may comprise a moisture resistant foil. Preferably the second cover is itself also provided with a protector layer, e.g. a plastics covering, such as a polymer sheet. The moisture resistant foil may preferentially be an aluminium foil. This may be an aluminium foil conventionally used in the art.

The cover/opening component, may be a moulding incorporating a boss or bosses that correspond to the orifices in the container, the opening action would then be, that the cover is first pressed down onto the container sheering the foil into the orifice and then raising the cover (as originally intended) to open the container.

The medicament container assembly may be manufactured using conventional means known per se. Thus, the components, e.g. the medicament compartment (whether an integral moulded plastics compartment or a walled chamber with a non integral base); the first cover; the second cover and, optionally the plastics protector layer, will be bonded together. The bonding may comprise the use of conventionally known adhesives. However, it is an especially advantageous aspect of the present invention that the components may be welded together, e.g. by use of an electromagnetic beam, such as, laser welding.

Thus, alternatively, the second cover as hereinbefore described, may itself be a laminate material, i.e. a foil material provided with a polymer coating, preferentially such a polymeric coating will be provided on the surface of the foil adjuvant the compartment. The use of such a foil/polymer laminate is advantageous, inter alia, in that it facilitates laser welding. Thus, although a variety of polymer coatings may be utilised, preferably the laminate polymer is laser absorbent, for example, the laminate polymer may contain a carbon black pigment. Although a variety of laminate polymers may be used, one such polymer is polypropylene. However, an especially preferred laminate polymer is also, moisture resistant and one such laminate polymer is Topas available in the USA from Ticona. Topas is a cycloolefin copolymer (COC) which possesses the properties transparency, moisture barrier effect, stability and (within limits) heat resistance.

The thickness of the foil and/or the foil laminate, may vary, but may preferentially be from 6 to 10 μm, preferably from 7 to 9 μm and especially 8 μm in thickness.

The technique of laser welding has been used for some time in metal-to-metal bonding, e.g. in the automotive industry. However, more recently it has been used in connection with medical devices, such as catheters. However, the use of laser welding in connection with medical devices such as inhalers and more especially medicament containers is novel per se.

Thus, according to a further aspect of the invention we provide a medicament container assembly comprising a medicament compartment and at least a first cover wherein the medicament compartment and the cover are bonded together by use of an electromagnetic beam, e.g. laser welded.

In a preferred aspect of this embodiment of the invention we provide a medicament container assembly comprising a medicament compartment; a first cover including a preformed medicament outlet; and a second cover as hereinbefore described, wherein the medicament compartment and the cover are laser bonded together.

Advantageously, the second cover/opening component may be provided with one or more bosses that correspond to the orifices in the assembly i.e. the preformed medicament outlet and optionally the air inlet. In this embodiment, the opening action comprises first pressing down the embossed second cover onto the first cover thus sheering, e.g. the foil into the orifice. The cover is then raised to open the container.

It is a novel feature of this aspect of the invention to laser bond together at least two materials wherein at least one of the materials is a metal, e.g. aluminium and the other is a plastics material.

When the medicament container comprises a plurality of components a variety of bonding means may be used for bonding two or more of the components. However, in the preferred aspect of the invention each of the bonded components are bonded using an electromagnetic beam, e.g. laser welded.

Although there are a number of approaches that may be adopted for laser welding of plastics, however, in the present invention the preferred method is “transmission welding”, since it is precise and controllable. A variety of lasers may be used depending upon the nature of the materials involved in the weld, however a laser diode which is preferred as an aspect of the present invention is a thermal infra red laser and more preferably a near infra red laser, e.g. a high powered laser operating at a wavelength of from 0.75-5 μm

Thus according to a yet further aspect of the invention we provide a method of manufacturing a medicament container as hereinbefore described which generally comprises the step of placing at least two of the components of the medicament container adjacent to one another and then directing an electromagnetic beam generally toward the location to be bonded. In the method of the invention, the electromagnetic beam as hereinbefore described preferably comprises is a thermal infra red laser and more preferably a near infra red laser, e.g. a high powered laser operating at a wavelength of from 0.75-5 μm.

In the method of manufacturing it is desirable to avoid the medicament coming into contact with the surfaces to be welded. This may be achieved by carefully skimming off any excess medicament. Alternatively, or in addition, the surface to be welded may, for example, be dabbed with an adhesive coated pad to lift off any remaining residual medicament. In a yet further alternative, the container may be filled with medicament and prior to filling the surfaces to be welded may be masked. By way of example only, the process could comprise the steps of 1) position the mask, 2) flood with medicament, 3) skim off excess medicament, 4) lift away the mask.

Generally, at least one of the components should comprise an energy absorption material. Preferably the most of the materials used are energy absorbing materials. In particular, the material(s) used in the construction of the medicament container of the invention is selected so as to absorb the maximum energy from the chosen wavelength of the electromagnetic energy. The material may optionally include a dye or pigment capable of absorbing radiation in the required wavelength range. Thus, heat is transferred from or through the energy absorption material causing the contact portion to melt and a bond to form.

In use, the second cover of the medicament container assembly is sheared away from the first cover rather than being ruptured. As hereinbefore described, this provides an advantage over prior art devices in that that the container may be reclosed. Such a reclosable device is novel per se.

Thus, according to a further aspect of the invention we provide an openable medicament container assembly wherein the assembly is closable after being opened.

Preferably, according to this aspect of the invention we provide a medicament container assembly comprising a medicament compartment; a first cover including a preformed medicament outlet; and an openable second cover wherein the second cover is reclosable.

The medicament container of the invention may also be one of a plurality of such containers arranged in series, which containers are able to transfer a succession of metered doses of powder into the inhalation passage of a dry powder inhaler. When a plurality of medicament containers is connected together, the series of containers may be comprised of a cartridge with a plurality of containers arranged around its periphery. In such a case the medicament containers themselves may be connected together.

The invention thus also provides a plurality of medicament containers arranged in series, each container being as hereinbefore described. The containers may be releasably or permanently attached to one another so as to be in a chain-like conformation, preferably a flexible or semi-flexible chain. The design of medicament containers in accordance with the invention makes such flexibility possible.

A series of medicament containers in accordance with this aspect of the invention is ideal for use in an inhaler, e.g. a dry powder inhaler. In an especially preferred embodiment the plurality of dosage units are contained in a cartridge and such a cartridge forms a further aspect of the invention.

Thus, according to a further feature of the invention we provide a medicament delivery device comprising a medicament container as hereinbefore described. In a most preferred embodiment the medicament is a powdered medicament and therefore, preferably, the delivery device is a powder delivery device, such as an inhaler, e.g. a dry powder inhaler.

Thus, according to a further feature of the invention we provide a dry powder inhaler comprising one or more medicament containers as hereinbefore described. In a further embodiment we provide an inhaler as hereinbefore described comprised a plurality of such medicament containers.

When the powder delivery device comprises an inhaler as hereinbefore described the powder channel of the shearing member may comprise an air channel and/or an aerosolisation channel. Whilst, generally, the powder/air channel in the shearing member is adapted for the removal of powdered medicament, e.g. in aerosolised form, from the medicament container, it may also be used to introduce, e.g. flushing air in the medicament container.

A variety of medicaments may be administered by using the inhaler of the invention. Such medicaments are generally suitable for the treatment of asthma, COPD and respiratory infections. Such medicaments include, but are not limited to β2-agonists, e.g. fenoterol, formoterol, pirbuterol, reproterol, rimiterol, salbutamol, salmeterol and terbutaline; non-selective beta-stimulants such as isoprenaline; xanthine bronchodilators, e.g. theophylline, aminophylline and choline theophyllinate; anticholinergics, e.g. ipratropium bromide; mast cell stabilisers, e.g. sodium cromoglycate and ketotifen; bronchial anti-inflammatory agents, e.g. nedocromil sodium; and steroids, e.g. beclomethasone dipropionate, fluticasone, budesonide, flunisolide and ciclesonide, and isomers and/or salts or derivatives thereof.

Specific combinations of medicaments which may be mentioned include combinations of steroids, such as, beclomethasone dipropionate and formoterol; beclomethasone dipropionate and salmeterol; fluticasone and formoterol; fluticasone and salmeterol; budesonide and formoterol; budesonide and salmeterol; flunisolide and formoterol; and flunisolide and salmeterol. It is also within the scope of this invention to include combinations of one or more of the aforementioned steroids with one or more of the aforementioned β2-agonists.

However, there is increasing interest in the pulmonary delivery of medicaments due, inter alia, to the rapid onset of their efficacious effect. Thus, further medicaments which may be mentioned include systemically active materials, such as, proteinaceous compounds and/or macromolecules, for example, hormones and mediators, such as insulin, human growth hormone, leuprolide and alpha interferon, growth factors, anticoagulants, immunomodulators, cytokines and nucleic acids. Other medicaments which may be mentioned are those for the treatment of neurological disorders, such as Parkinsonism, such as, levodopa, carbidopa, benserazide, selegiline, tolcapone, entacapone, bromocriptine, lysuride, pergolide, ropinirole and cabergoline; or migraine, such as divalroex sodium, ergotamine, methysergide, metoprolol, propranolol, zolmitriptan, vigabatrine, clonidine, ganaxolone, lysine acetylsalicylate, sumatriptan, naratriptan, timolol, almotriptan, cyproheptadine, rizatriptan, timotol, dotarizine, dihydroergotamine, metysergide, pizotifen, eletriptan, prochlorperazine, nadolol and frovatriptan. In addition, medicaments for the treatment of sexual dysfunction may be mentioned. Such disorders include erectile dysfunction where treatments include administration of phosphodiesterase type-5 (PDTE5) inhibitors, such as tadalafil, vardenafil and sildenafil; and premature ejaculation, where treatments include administration of selective serotonin reuptake inhibitors, such as dapoxetine.

According to a further aspect of the invention we provide a method of delivering a medicament, e.g. a powdered medicament, which comprises the use of a delivery device as hereinbefore described.

We especially provide a method of the pulmonary delivery of a medicament, e.g. a powdered medicament, which comprises the use of an inhaler as hereinbefore described.

### BRIEF DESCRIPTION OF THE DRAWINGS

The invention will now be described by way of example only and with reference to the accompanying drawings in which

FIG. 1 is a perspective representation of the medicament container of the invention;

FIGS. 2 (a) to (c) are cross-sectional side views of the container;

FIG. 3 is a disassembled perspective view of the container;

FIGS. 4 (a) to (f) are perspective views of the assembly of the container;

FIGS. 5 (a) to (c) are perspective views of the container applied to a strip;

FIGS. 6 (a) to (c) are perspective views of the container illustrating variations in the inlet/outlet;

FIGS. 7 (a) and (b) are perspective views of the container illustrating variations in the compartment; and

FIGS. 8 (a) and (b) are perspective views of the container optionally in a moisture protective sleeve.

### DETAILED DESCRIPTION OF THE INVENTION

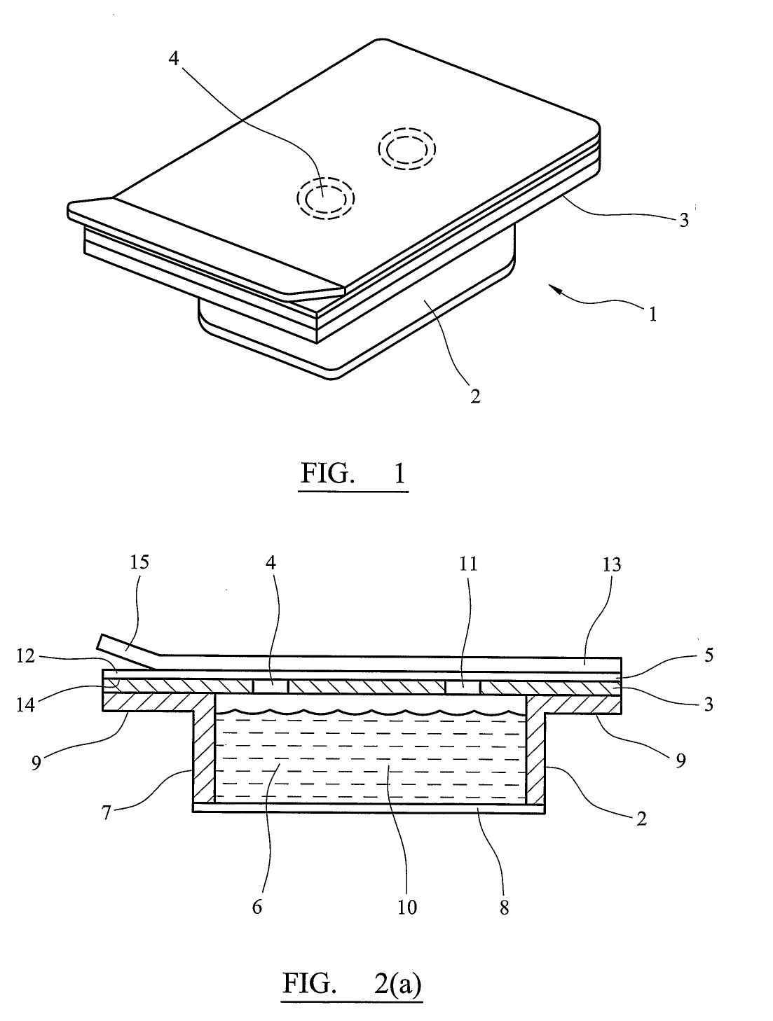

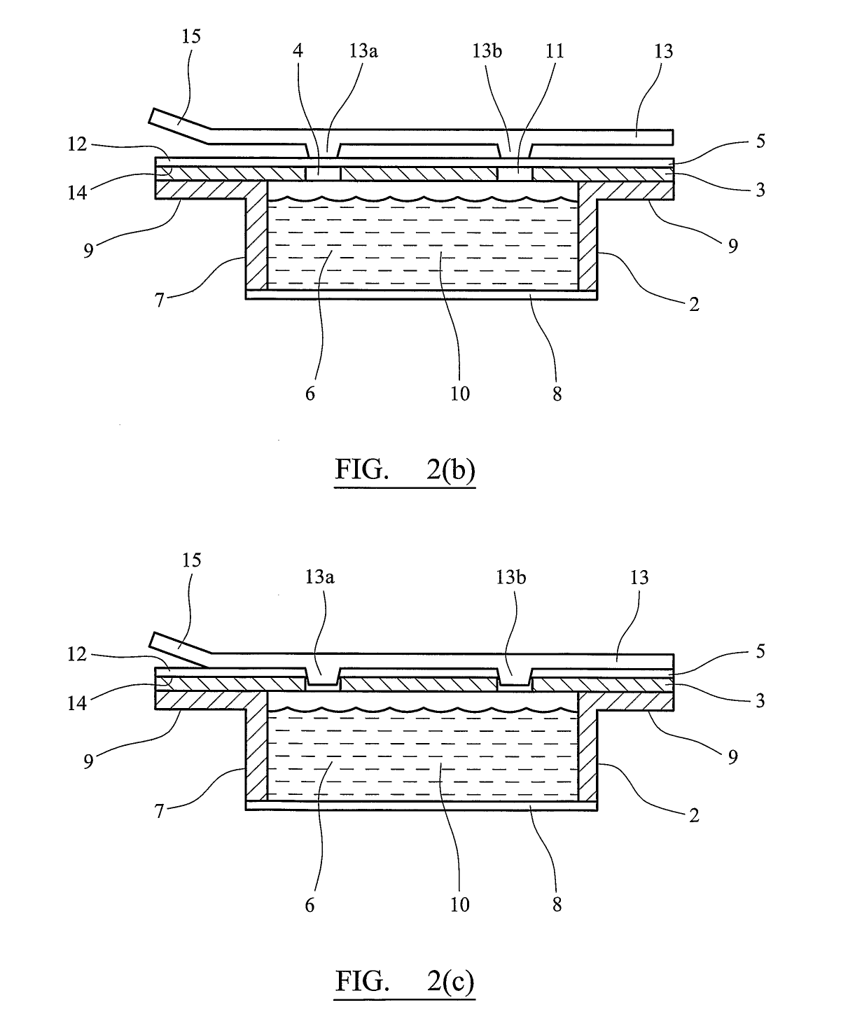

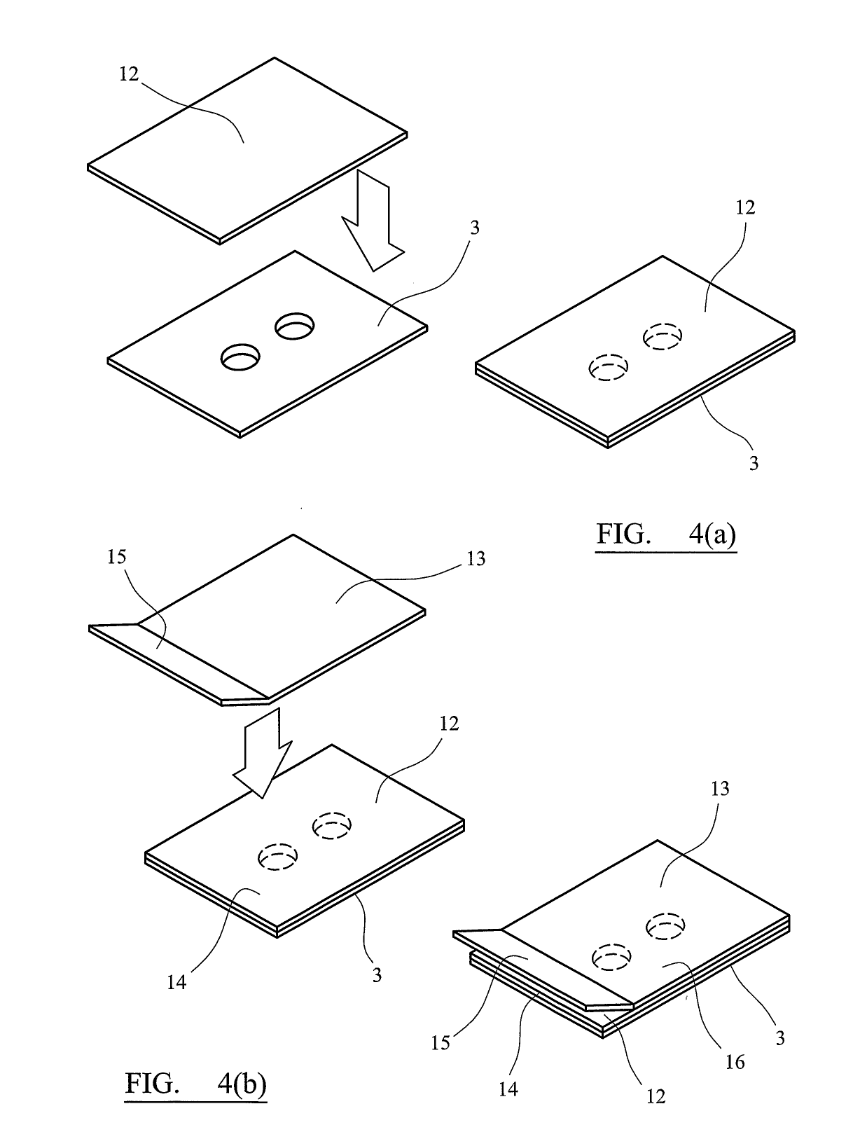

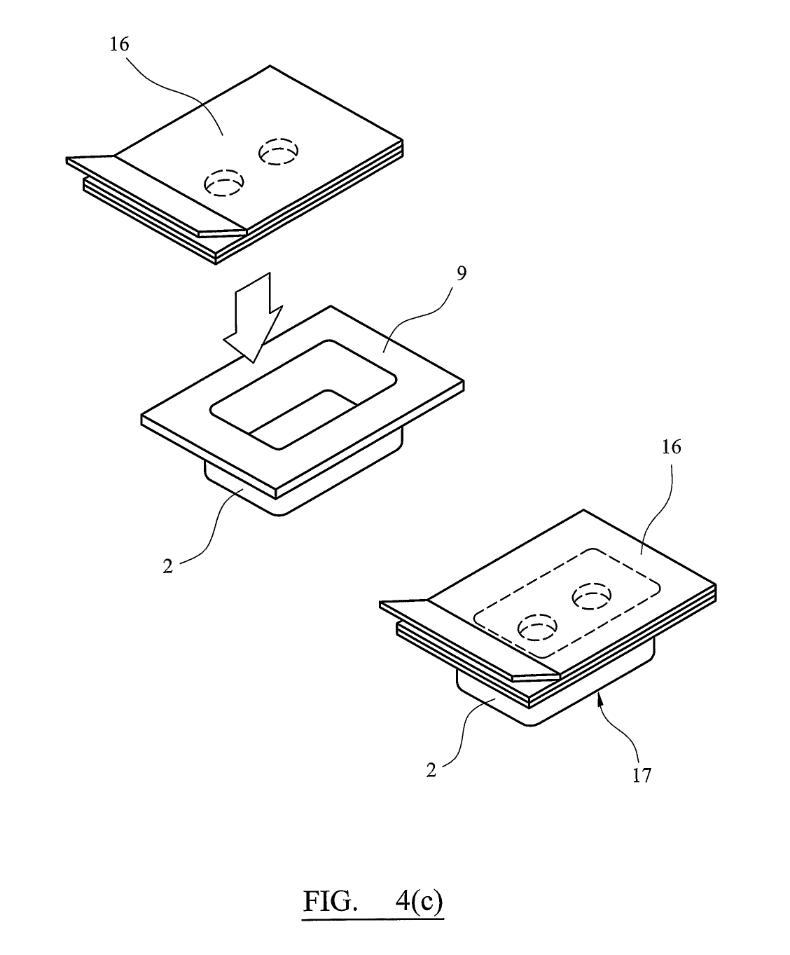

Referring to FIGS. 1 to 3, a medicament container assembly (1) comprises a medicament compartment (2); a first cover (3) including a preformed medicament outlet (4) and a second cover (5).

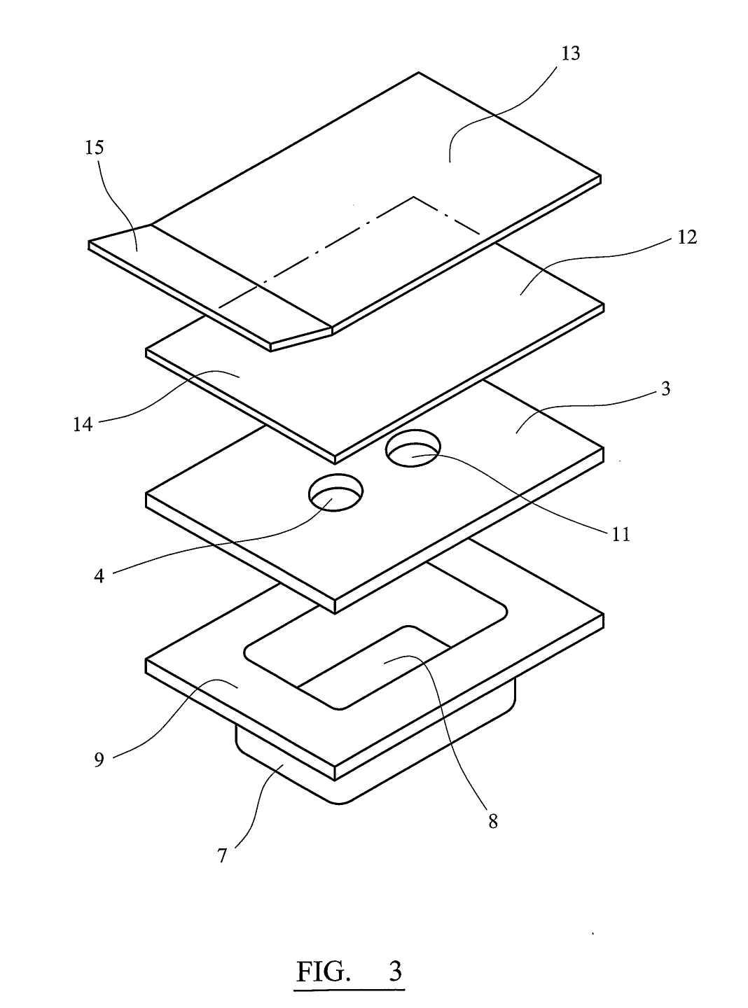

The medicament compartment (2) comprises a chamber (6) with a wall 70 and a base (8). The compartment (2) is also provided with a circumferential lip (9). In FIG. 2 the medicament (10) is also shown. The compartment (2) is substantially closed by a first cover (3). The first cover (3) is provided with a preformed medicament outlet (4) and an air inlet (11). The first cover (3) overlays and is sealed against the circumferential lip (9). The plastics first cover (3) is sealed with a second cover (5).

The second cover (5) comprises a moisture resistant foil strip (12) and is overlaid and bonded to a semi-rigid plastics sheet (13). Along an edge (14) of the foil strip (12) and a corresponding edge (15) of the semi-rigid plastics sheet (13) the bonding is absent so that the edge (15) of the semi-rigid plastics sheet (13) may be gripped.

In the embodiment of FIGS. 2(b) and 2(c) the semi-rigid plastics sheet (13) is provided with a pair of bosses (13(a) and 13(b)). The bosses (13(a) and 13(b)) generally correspond to the medicament outlet (4) and the air inlet (11). In use, the cover (13) containing the bosses (13(a) and 13(b)) is first pressed down sheering the foil strip cover (12).

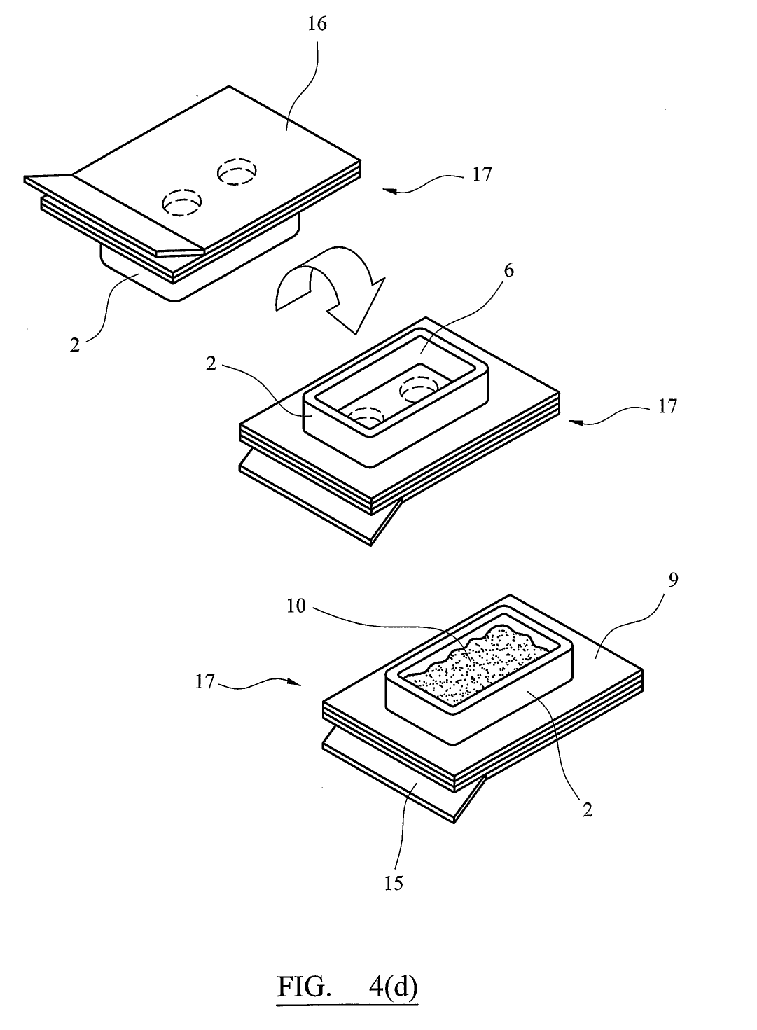

Referring to FIGS. 4 (a) to (f), which illustrate the assembly of the container (1), and FIG. 4(a) in particular, the moisture resistant foil strip (12) is positioned on top of the first cover (3) and the two are bonded (laser welded) together. Referring to FIG. 4(b) the semi-rigid plastics sheet (13) is laid over the moisture resistant foil strip (12) and, with the exception of the respective edges (14) and (15), the semi-rigid plastics sheet (13) and the moisture resistant foil strip (12) are bonded (laser welded) together to form a composite lid (16). Referring to FIG. 4(c) the composite lid (16) is positioned over the circumferential lip (9) of the medicament compartment (2) and the lid (16) and lip (9) are bonded together. Referring to FIG. 4(d) the intermediate assembly (17), absent a base (8) is inverted and the chamber (6) is substantially filled with medicament powder (10). It is an option of the present invention that the chamber (6) may be filled with a predetermined measured amount of the powdered medicament (10) or alternatively, the chamber (6) may be dimensioned so as to only hold predetermined amount, thus it may be filled with an excess amount of the powdered medicament (10) and by, for example, skimming the exposed surface of the powdered medicament (10) a uniform amount of powdered medicament (10) may remain. This latter alternative method of filling the medicament container assembly of the invention is considered to present a particular advantage over prior art methods. Referring to FIG. 4(e), the base (8) of the chamber (6) is then positioned on the walls (7) of the chamber (6) and bonded together to form a sealed container (1). Referring to FIG. 4(f) the medicament container (1) can then be reinverted and ready for use.

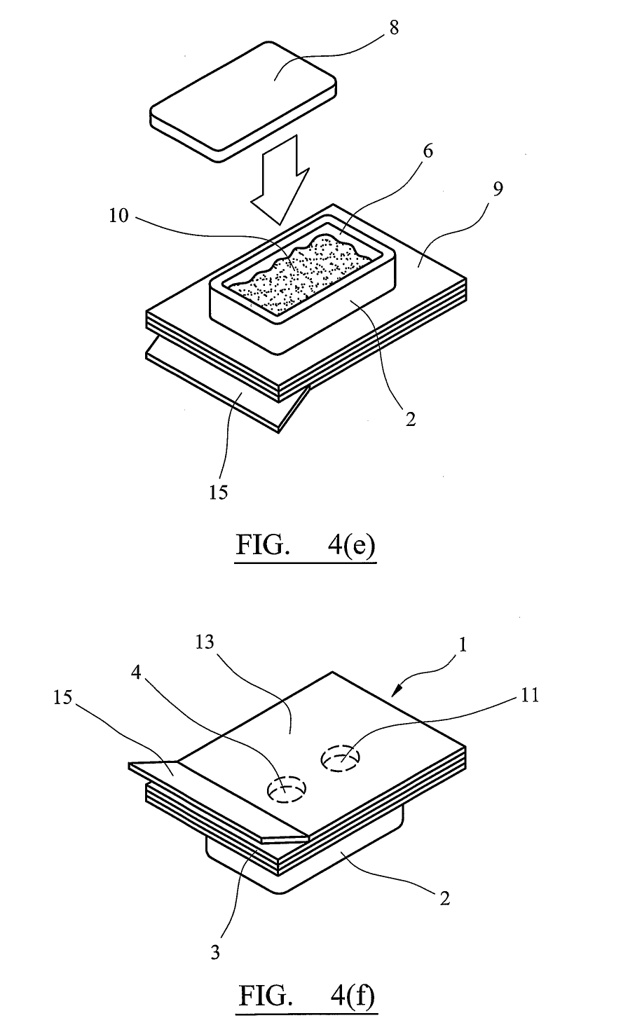

Referring to FIGS. 5(a) to (c), which illustrate the assembly of a plurality of containers (1), and FIG. 5(a) in particular, a plurality of containers (1) are assembled in a longitudinal strip (18). In use, the composite lid (16) is peeled away, exposing the first cover (3) and the apertures (4) and (11). Referring to FIG. 5(b) a plurality of containers (1) is assembled in a transverse strip (19). In use, the composite lid (16) is peeled away, exposing the first cover (3) and the apertures (4) and (11) and may be resealed. Referring to FIG. 5(c) a plurality of containers (1) is assembled in an integrated cartridge or carousel (20). A plurality of the chambers (6) is in the form of a disc (21) and the first cover (3) is in the form of a corresponding disc (22). The corresponding foil cover (12) and plastics cover (13) are also in the form of corresponding discs (22) and (23). In the embodiment shown, the discs (22) and (23) are in the form of serrated discs. In use, the composite lid (16) is peeled away exposing the first cover (3) and the apertures (4) and (11) and may be resealed.

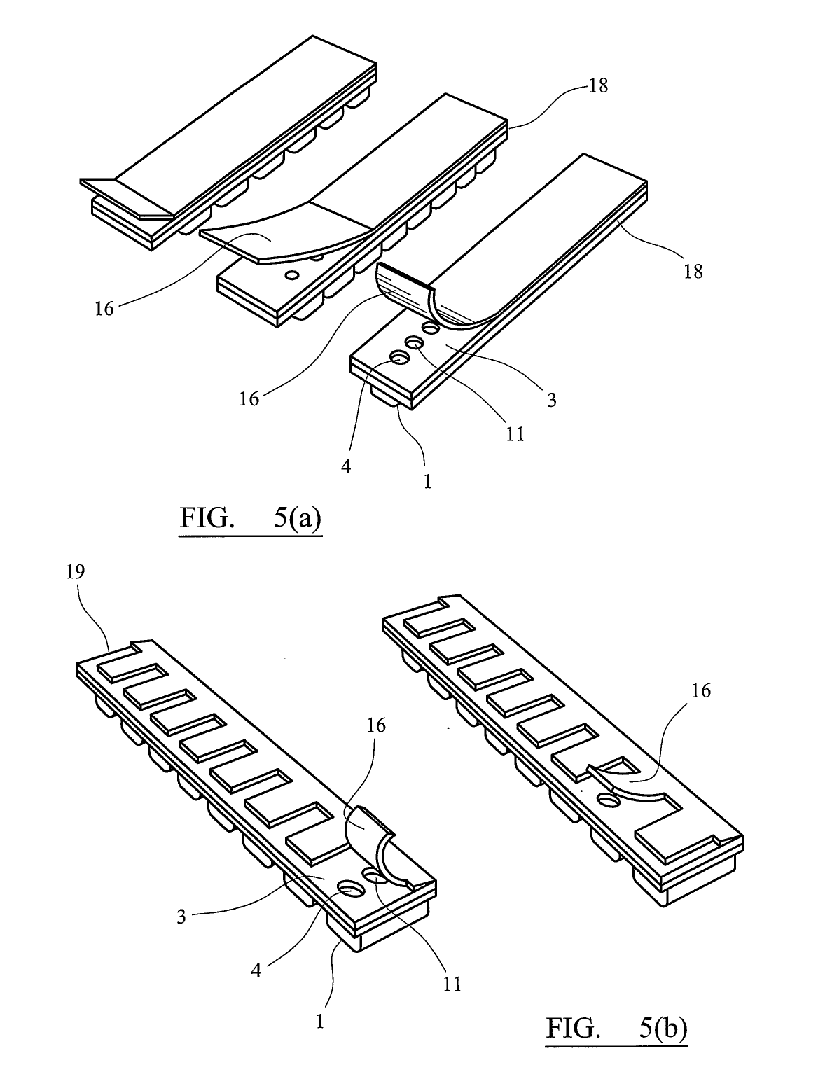

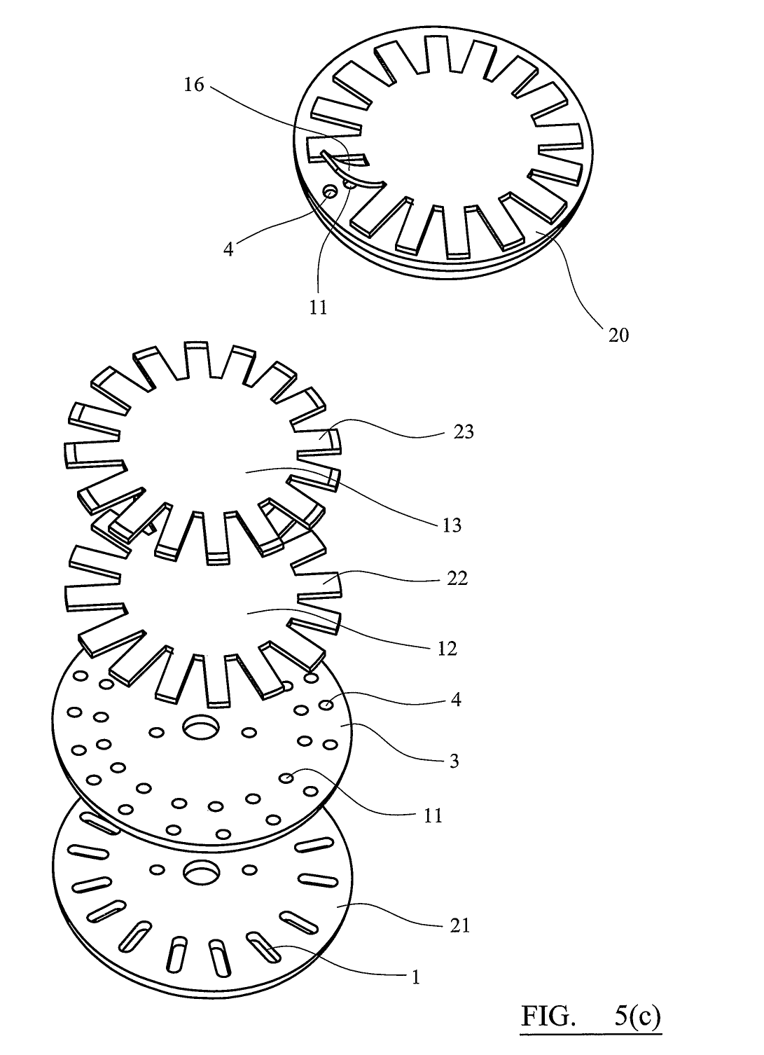

Referring to FIG. 6, a disassembled medicament container (1) is shown. FIG. 6(a) illustrates a first cover (3) wherein the outlet aperture (4) is smaller than the inlet aperture (11) enabling tuning of the outlet air/medicament stream (not shown). FIG. 6(b) illustrates a first cover (3) wherein the inlet aperture (11) is in the form of a grill (24) facilitating the deagglomeration of a powdered medicament. FIG. 6(c) illustrates a first cover (3) wherein a pair of inlet apertures (11a and 11b) and a pair of outlet apertures (4a and 4b) are provided facilitating the delivery of a combination therapy in a single dose.

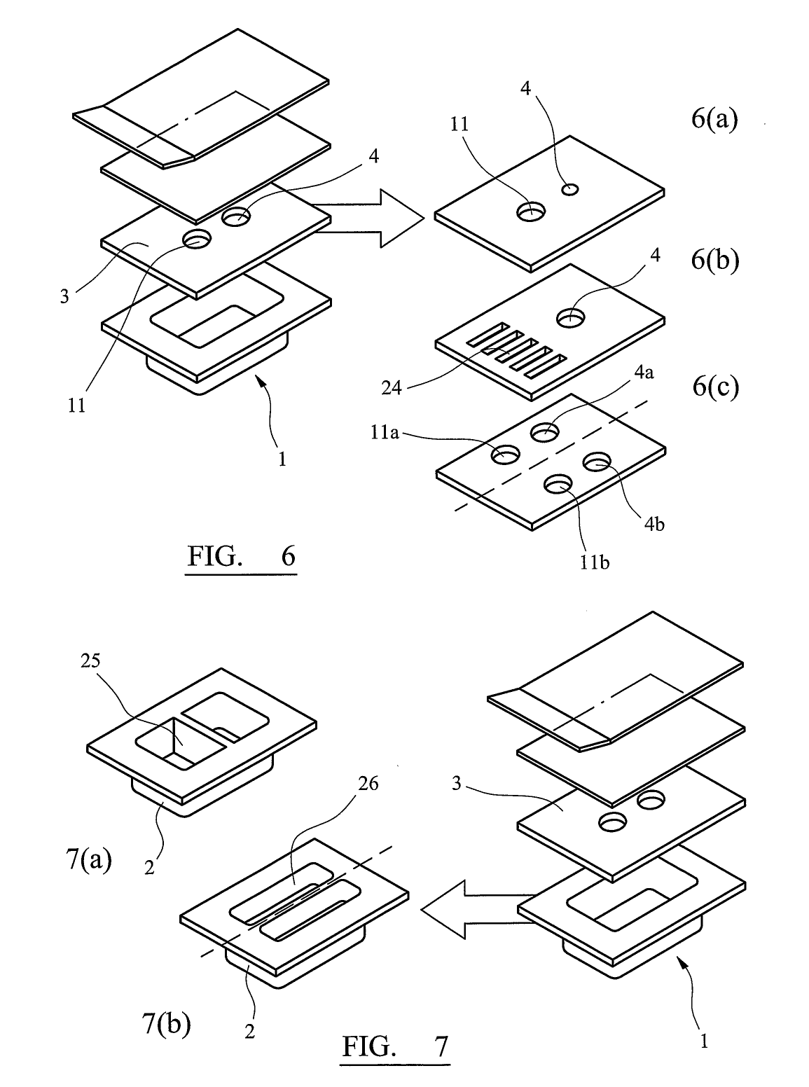

Referring to FIG. 7, a disassembled medicament container (1) is shown. FIG. 7(a) illustrates a medicament compartment (2) which includes a baffle (25) to facilitate the deagglomeration of the powdered medicament. FIG. 7(b) illustrates a medicament compartment (2) wherein a divider wall (26) is provided, facilitating the delivery of a combination therapy in a single dose.

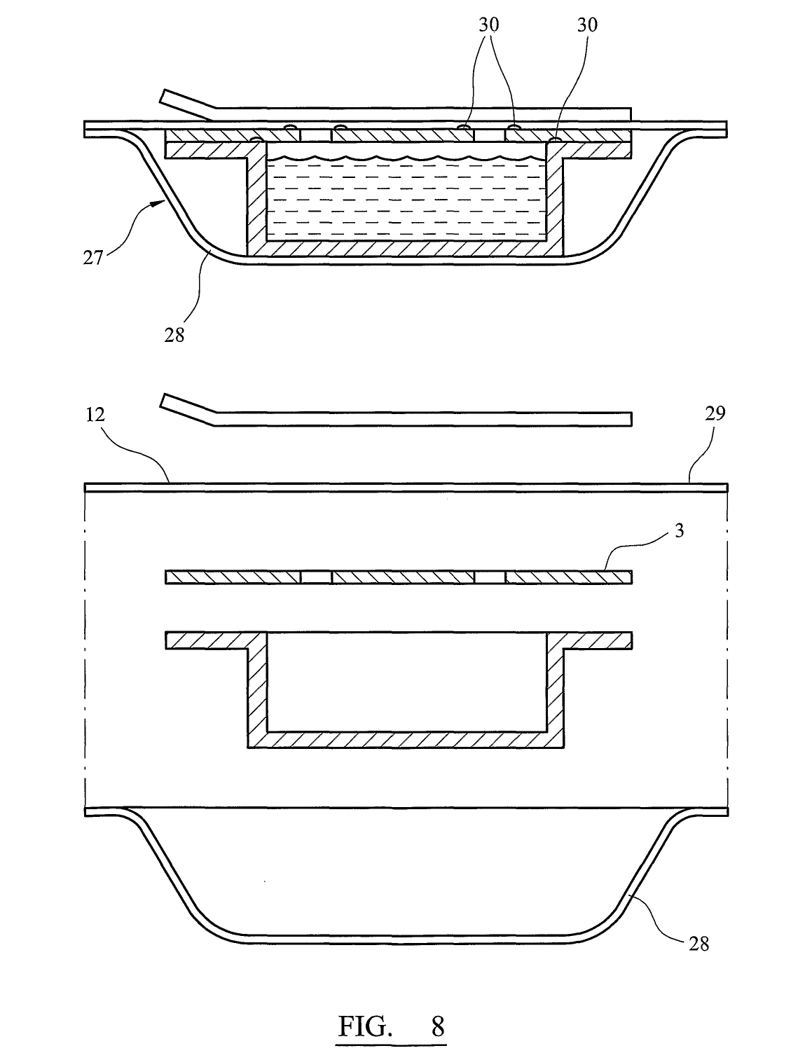

Referring to FIG. 8, a medicament container (1) incorporates a moisture protective sleeve (27). A separate basin (28) is provided, e.g. a foil basin (28) and the foil cover (12) is extended beyond the edge (29) of the first cover (3) enabling the foil cover (12) to be sealed against the foil basin (28), to form a sealed moisture resistant sleeve/container (27). Bond joints (31) are illustrated.

1. A medicament container assembly comprising a medicament compartment; a first cover including a preformed medicament outlet; and a second cover.

2. (canceled)

3. A medicament container assembly according to claim 1 wherein the medicament compartment comprises an integral moulded plastics compartment.

4. A medicament container assembly according to claim 1 wherein the assembly comprises a walled chamber with a non integral base.

5. A medicament container assembly according to claim 1 wherein the medicament compartment comprises a medicament retaining chamber and a lip and wherein the lip is substantially circumferential to the chamber.

6. A medicament container assembly according to claim 1 wherein first cover is a rigid or semi rigid preformed plastics cover adapted to be fitted to the medicament compartment.

7. A medicament container assembly according to claim 1 wherein the first cover is provided with a single medicament outlet and an air inlet.

8. A medicament container assembly according to claim 1 wherein the first cover is provided with a single medicament outlet and a plurality of air inlets.

9. A medicament container assembly according to claim 1 wherein the first cover is provided with a single medicament outlet and a plurality of air inlets in the form of a grill.

10. A medicament container assembly according to claim 1 wherein the first cover is provided with a single medicament outlet and an air inlet and wherein the air flow and/or the medicament flow may be tuned or regulated by the use of different sized apertures.

11. A medicament container assembly according to claim 1 wherein the medicament compartment comprises a medicament retaining chamber and a lip and wherein the first cover is preferentially sized and shaped so that it substantially overlies the lip of the compartment.

12. A medicament container assembly according to claim 1 wherein the compartment and the first cover both comprise plastics material.

13. A medicament container assembly according to claim 1 wherein the second cover comprises a moisture resistant material and wherein the moisture resistant material comprises a moisture resistant foil.

14. A medicament container assembly according to claim 1 wherein the second cover comprises a moisture resistant material and wherein the moisture resistant material comprises a moisture resistant foil laminate.

15. A medicament container assembly according to claim 1 wherein the second cover is itself also provided with a protector layer.

16. A medicament container assembly according to claim 1 for use with a dry powder inhaler wherein in use the medicament container may be sheared open and is closable after being opened.

17. A medicament container assembly comprising a medicament compartment and at least a first cover wherein the medicament compartment and the cover are bonded together by use of an electromagnetic beam.

18. A medicament container assembly according to claim 17 wherein the use of an electromagnetic beam comprises laser welding.

19. A medicament container assembly according to claim 17 wherein when the medicament container comprises a plurality of components and each of the bonded components are bonded using transmission laser welding.

20. A method of manufacturing a medicament container which comprises the step of placing at least two of the components of the medicament container adjacent to one another and then directing an electromagnetic beam generally toward the location to be bonded.

21. A method according to claim 20 wherein laminate at least one of the components comprises an energy absorption material which includes a dye or pigment capable of absorbing radiation in the required wavelength range.

22.-74. (canceled)
